(19) United States
(12) Patent Application Publication
(10) Pub. No.: US 2017/0153379 A1
(43) Pub. Date: Jun. 1, 2017

(54) TRANSMISSIVE DISPLAY MODULE AND DRIVING METHOD THEREOF

(71) Applicant: Young Lighting Technology Inc., Hsin-Chu (TW)

(72) Inventors: Jung-Wei Chang, Hsin-Chu (TW); Yi-Yu Tsai, Hsin-Chu (TW); Hsin-Hung Lee, Hsin-Chu (TW); Chiao-Chih Yang, Hsin-Chu (TW)

(21) Appl. No.: 15/199,955

(22) Filed: Jun. 30, 2016

(30) Foreign Application Priority Data
Nov. 27, 2015 (CN) 201510847280.4

(51) Int. Cl. F21V 8/00

(52) U.S. Cl. CPC G02B 6/0063; G02B 6/0076; G02B 6/0068; G02B 6/0081; G02B 6/0043

(57) ABSTRACT

The invention provides a transmissive display module and a driving method thereof. The transmissive display module includes a transparent display panel, a first light source module, a second light source module and at least one adhesive layer. The first light source module and the second light source module are respectively disposed on opposite surfaces of the transparent display panel. The first light source module includes a first light guide plate and a first light source, and the second light source module includes a second light guide plate and a second light source. The adhesive layer at least adheres the transparent display panel and the first light guide plate, and a refractive index of the adhesive layer is less than a refractive index of the first light guide plate.

### CROSS-REFERENCE TO RELATED APPLICATION

This application claims the priority benefit of China application serial no. 201510847280.4, filed on Nov. 27, 2015. The entirety of the above-mentioned patent application is hereby incorporated by reference herein and made a part of this specification.

### BACKGROUND OF THE INVENTION

Field of the Invention

The invention is related to a display module and a driving method thereof and more particularly, to a transmissive display module and a driving method thereof.

Description of Related Art

A transmissive display module is a display module with a specific light-transmittance and can not only display an image frame, but also provide a user with an image in the back of the display module. Thus, the transmissive display module is commonly applied in objects, such as building windows, car windows and shop windows, which require light transmittance as well as the capability of displaying image frames.

A conventional transmissive display module employs ambient light as a light source required for displaying. However, when the ambient light is insufficient, brightness of the transmissive display module would be too low for the user to view the image frames clearly. Therefore, a technique of constructing a light source module in the transmissive display module is proposed to solve the issue of insufficient brightness. Nevertheless, the transmissive display module still have issues, such as weak mechanical strength and light emitting unevenness.

The information disclosed in this “BACKGROUND OF THE INVENTION” section is only for enhancement of understanding of the background of the described technology, and therefore it may contain information that does not form the prior art that is already known to a person of ordinary skill in the art. Further, the information disclosed in this “BACKGROUND OF THE INVENTION” section does not mean that one or more problems to be resolved by one or more embodiments of the invention was acknowledged by a person of ordinary skill in the art.

### SUMMARY OF THE INVENTION

The invention is directed to a transmissive display module with ideal mechanical strength and light emitting uniformity. The invention is also directed to a driving method of the transmissive display module.

Additional aspects and advantages of the invention will be set forth in the description of the techniques disclosed in the invention.

To achieve one of, a part of or all of the above-mentioned advantages, or to achieve other advantages, an embodiment of the invention provides a transmissive display module including a transparent display panel, a first light source module, a second light source module and at least one adhesive layer. The first light source module is disposed on the transparent display panel and includes a first light guide plate and a first light source. The first light guide plate has a first light incident surface. The first light source is disposed beside the first light incident surface. The second light source module is disposed on a surface of the transparent display panel which is opposite to the first light source module and includes a second light guide plate and a second light source. The second light guide plate has a second light incident surface. The second light source is disposed beside the second light incident surface. The adhesive layer at least adheres the transparent display panel and the first light guide plate, and a refractive index of the adhesive layer is less than a refractive index of the first light guide plate.

To achieve one of, a part of or all of the above-mentioned advantages, or to achieve other advantages, an embodiment of the invention provides a driving method of a transmissive display module. The driving method includes the following steps. A transmissive display module is provided. The transmissive display module includes a transparent display panel, a first light source module and a second light source module, the first light source module is disposed on the transparent display panel and includes a first light source, and the second light source module is disposed on a surface of the transparent display panel which is opposite to the first light source module and includes a second light source. In a transparent mode, the first light source and the second light source are turned off to induce the transmissive display module to present a transparent state. In a unidirectional display mode, one of the first light source and the second light source is turned on to display an image frame on one side of the transmissive display module. In a bi-directional display mode, the first light source and the second light source are turned on to respectively display image frames on two opposite sides of the transmissive display module.

To sum up, the embodiments of the invention achieve at least one of the advantages and effects set forth below. In the transmissive display module of the invention, the adhesive layer adheres the transparent display panel and the first light guide plate, such that the mechanical strength can be improved. In addition, the refractive index of the adhesive layer is less than the refractive index of the first light guide plate, and thus, a light beam from the first light source which enters the first light guide plate can be transmitted in the first light guide plate by means of total internal reflection, so as to achieve an effect of uniform distribution. Therefore, the transmissive display module of the invention cam have ideal mechanical strength and light emitting uniformity. Moreover, the driving method of the transmissive display module of the invention can provide various display modes by controlling the turning on and the turning off of the first light source and the second light source and a timing sequence of the transparent display panel.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 to FIG. 4 are schematic diagrams respectively illustrating a transmissive display module according to a first to a fourth embodiments of the invention.

FIG. 5 is a flowchart illustrating a driving method of a transmissive display module according to an embodiment of the invention.

FIG. 6 is a schematic diagram illustrating the transmissive display module in a transparent mode.

FIG. 7 and FIG. 8 are schematic diagrams respectively illustrating the transmissive display module in a unidirectional display mode.

FIG. 9 and FIG. 10 are schematic diagrams respectively illustrating the transmissive display module in a bi-directional display mode.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

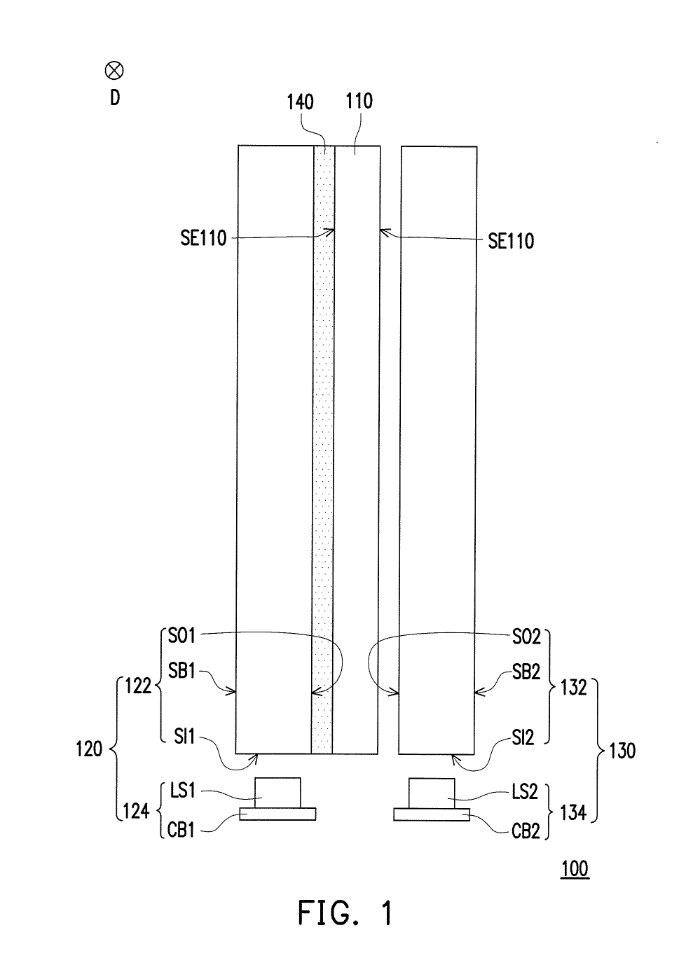

FIG. 1 to FIG. 4 are schematic diagrams respectively illustrating a transmissive display module according to a first to a fourth embodiments of the invention. Referring to FIG. 1, a transmissive display module 100 includes a transparent display panel 110, a first light source module 120, a second light source module 130 and at least one adhesive layer 140.

The transparent display panel 110 is, for example, an active light valve display panel and is, for example, a non-self-luminescent transparent display panel, such as a liquid crystal display (LCD) panel or an electro-wetting display panel, but the invention is not limited thereto.

The transparent display panel 110 has two opposite image output surfaces SE110. The first light source module 120 is disposed on the transparent display panel 110 and on one of the image output surfaces SE110. The first light source module 120 may be a side-type light source module. Specifically, the first light source module 120 may include a first light guide plate 122 and a first light source 124.

The first light guide plate 122 has a first light incident surface SI1, a first light emitting surface SO1 and a first bottom surface SB1. The first bottom surface SB1 is opposite to the first light emitting surface SO1, and the first light emitting surface SO1 is located between the first bottom surface SB1 and the transparent display panel 110. The first light incident surface SI1 connects the first light emitting surface SO1 and the first bottom surface SB1. The first light source 124 is disposed beside the first light incident surface SI1 and configured to emit a light beam (not shown) toward the first light incident surface SI1. The first light source 124 includes at least one first light emitting element LS1. Though only one first light emitting element LS1 is schematically illustrated in FIG. 1, the invention is not limited thereto. In another embodiment, the first light source 124 may include a plurality of first light emitting elements LS1, and the first light emitting elements LS1 are arranged, for example, along a direction D which is parallel to the first light incident surface SI1 and parallel to the first light emitting surface SO1. Additionally, the first light source 124 may also include a circuit board CB1, where the first light emitting element LS1 is disposed on a surface of the circuit board CB1 which faces toward the first light incident surface SI1 and is electrically connected with a transmission wire on the circuit board CB1.

The second light source module 130 is disposed on a surface of the transparent display panel 110 which is opposite to the first light source module 120 (i.e., the other image output surface SE110). The second light source module 130 may be a side-type light source module. Specifically, the second light source module 130 may include a second light guide plate 132 and a second light source 134.

The second light guide plate 132 has a second light incident surface SI2, a second light emitting surface SO2 and a second bottom surface SB2. The second bottom surface SB2 is opposite to the second light emitting surface SO2, and the second light emitting surface SO2 is located between the second bottom surface SB2 and the transparent display panel 110. The second light incident surface SI2 connects the second light emitting surface SO2 and the second bottom surface SB2. The second light source 134 is disposed beside the second light incident surface SI2 and configured to emit a light beam (not shown) toward to the second light incident surface SI2. The second light source 134 includes at least one second light emitting element LS2. Though only one second light emitting element LS2 is schematically illustrated in FIG. 1, the invention is not limited thereto. In another embodiment, the second light source 134 may include a plurality of second light emitting elements LS2, and the second light emitting element LS2 are arranged, for example, along the direction D. Additionally, the second light source 134 may also include a circuit board CB2, where the second light emitting element LS2 is disposed on a surface of the circuit board CB2 which faces toward the second light incident surface SI2 and is electrically connected with a transmission wire on the circuit board CB2. In another embodiment, the circuit board CB1 and the circuit board CB2 may also integrated as one circuit board, but the invention is not limited thereto. The first light emitting element LS1 and the second light emitting element LS2 are, for example, light emitting diodes (LEDs), laser diodes (LDs) or other adaptive light emitting elements capable of providing light beams, but the invention is not limited thereto.

The adhesive layer 140 adheres the transparent display panel 110 and the first light guide plate 122 and, for example, adheres the first light emitting surface SO1 of the first light guide plate 122 and its corresponding image output surface SE110 of the transparent display panel 110. A refractive index of the adhesive layer 140 is less than a refractive index of the first light guide plate 122. Specifically, the refractive index of the adhesive layer 140 is less than 95% of the refractive index of the first light guide plate 122. For instance, a material of the first light guide plate 122 includes, for example, polymethyl methacrylate (PMMA) or glass. Refractive indexes of PMMA and glass are 1.49 and 1.52, respectively, but the invention is not limited thereto. A material of the adhesive layer 140 includes, for example, a material having a refractive index less than or equal to 1.4, e.g., Norland Optical Adhesives 132, 133, 138, 1315, 1327, 1328, 1375, 13685, etc., but the invention is not limited thereto.

With the adhesive layer 140 adhering the transparent display panel 110 and the first light guide plate 122, not only the volume of the transmissive display module 100 may be effectively reduced, but also mechanical strength of the transmissive display module 100 may be improved. Additionally, each first light emitting element LS1 disposed correspondingly to the first light guide plate 122 may be a narrow distribution angle light emitting element, such that most of the light beam from the first light emitting element LS1 enters the first light guide plate 122 to enhance light utilization efficiency. The narrow distribution angle light emitting element refers to a light distribution angle corresponding to 50% of a light intensity of each first light emitting element LS1 falling in a range less than or equal to 55 degrees, and a sum of light energy of each first light emitting element LS1 at a light distribution angle greater than or equal to 70 degrees being less than or equal to 10% of a lumen value of each first light emitting element LS1.

Due to the refractive index of the adhesive layer 140 being less than the refractive index of the first light guide plate 122, the light beam from the first light source 124 which enters the first light guide plate 122 is capable of being transmitted in the first light guide plate 122 by means of total internal reflection, which achieves an effect of uniform distribution of the light beam. Thereby, the first light source module 120 is capable of providing a uniform surface light. In the embodiment, the second light source module 130 may be fixed on one side of the corresponding image output surface SE110 by a fixing member which is not shown. The second light guide plate 132 is kept in an adaptive distance from the image output surface SE110, and a transmission medium between the second light guide plate 132 and the image output surface SE110 is air. Due the air having a refractive index less than a refractive index of the second light guide plate 132, the light beam from the second light source 134 which enters the second light guide plate 132 is also transmitted in the second light guide plate 132 by means of total internal reflection, which achieves the effect of uniform distribution of the light beam. Thereby, the second light source module 130 is also capable of providing a uniform surface light. Therefore, the transmissive display module 100 has an advantage of uniformly emitting light.

Based on difference design requirements, the transmissive display module 100 may further include other elements. For instance, the transmissive display module 100 may further include a controller (not shown). The controller is electrically connected with the transparent display panel 110 to control a timing sequence of the transparent display panel 110. Additionally, the controller is electrically connected with the first light source module 120 and the second light source module 130 to control turning on and turning off of the first light source 124 and the second light source 134. The controller is, for example, an integrated circuit (IC) chip, but the invention is not limited thereto.

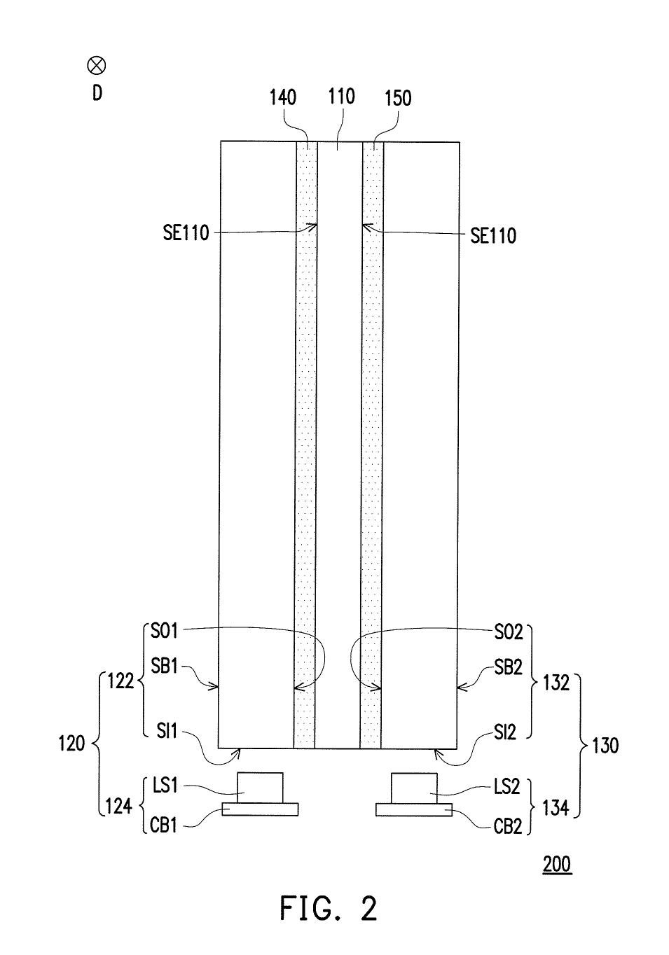

Other implementation aspects of the transmissive display module are introduced with reference to FIG. 2 to FIG. 4, therein, the same or similar reference numerals represent the same or similar elements in the following embodiments and thus, will not be repeatedly described. Referring to FIG. 2, the difference between a transmissive display module 200 illustrated in FIG. 2 and the transmissive display module 100 lies in the transmissive display module 200 further including an adhesive layer 150. The adhesive layer 150 adheres the transparent display panel 110 and the second light guide plate 132, and for example, adheres the second light emitting surface SO2 of the second light guide plate 132 and its corresponding image output surface SE110 of the transparent display panel 110. A refractive index of the adhesive layer 150 is less than the refractive index of the second light guide plate 132. Specifically, the refractive index of the adhesive layer 150 is, for example, less than 95% of the refractive index of the second light guide plate 132. For instance, a material of the second light guide plate 132 includes PMMA or glass, but the invention is not limited thereto. A material of the adhesive layer 150 may include a material having a refractive index less than or equal to 1.4, e.g., Norland Optical Adhesives 132, 133, 138, 1315, 1327, 1328, 1375, 13685, etc., but the invention is not limited thereto.

With the adhesive layer 150 adhering the transparent display panel 110 and the second light guide plate 132, not only the volume of the transmissive display module 200 may be effectively reduced, but also mechanical strength of the transmissive display module 200 may be improved. Additionally, each second light emitting element LS2 disposed correspondingly to the second light guide plate 132 may be a narrow distribution angle light emitting element, such that most of the light beam from the second light emitting element LS2 enters the second light guide plate 132. The narrow distribution angle light emitting element refers to a light distribution angle corresponding to 50% of a light intensity of each second light emitting element LS2 falling in a range less than or equal to 55 degrees, and a sum of light energy of each second light emitting element LS2 at a light distribution angle greater than or equal to 70 degrees being less than or equal to 10% of a lumen value of each second light emitting element LS2. Moreover, due to the refractive index of the adhesive layer 140 being less than the refractive index of the first light guide plate 122, and the refractive index of the adhesive layer 150 being less than the refractive index of the second light guide plate 132, the light beams from the first light source 124 and the second light source 134 which enter the corresponding light guide plates are capable of being transmitted in the light guide plates by means of total internal reflection, which achieve the effect of uniform distribution of the light beams. Thereby, both the first light source module 120 and the second light source module 130 are capable of providing uniform surface light. Therefore, the transmissive display module 200 has an advantage of uniformly emitting light.

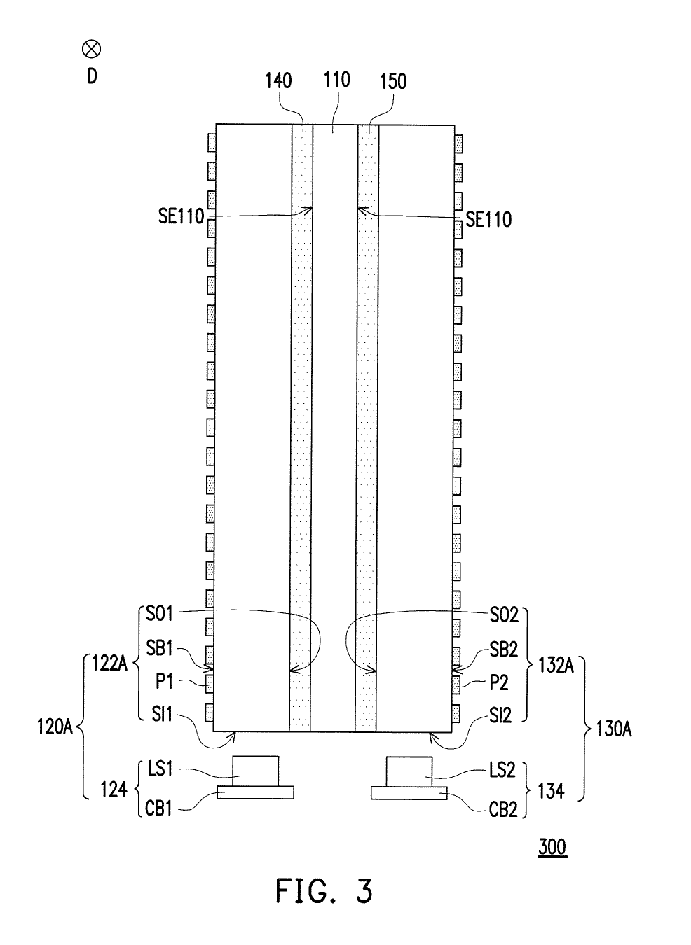

Referring to FIG. 3, the difference between a transmissive display module 300 illustrated in FIG. 3 and the transmissive display module 200 lies in a first light guide plate 122A of a first light source module 120A of the transmissive display module 300 further having a plurality of first transparent net points P1. The first transparent net points P1 are disposed on one of the first light emitting surface SO1 and the first bottom surface SB1 to frustrate the total internal reflection, such that the light beam transmitted in the first light guide plate 122A emits from at least one of the first light emitting surface SO1 and the first bottom surface SB1. Moreover, a second light guide plate 132A of a second light source module 130A of the transmissive display module 300 of the embodiment further has a plurality of second transparent net points P2. The second transparent net points P2 are disposed on one of the second light emitting surface SO2 and the second bottom surface SB2 to frustrate the total internal reflection, such that the light beam transmitted in the second light guide plate 132A emits from at least one of the second light emitting surface SO2 and the second bottom surface SB2. Materials of the first transparent net points P1 and the second transparent net points P2 may include ink, and the first transparent net points P1 and the second transparent net points P2 are formed on the corresponding surfaces in a printing manner or an inkjet manner, but the invention is not limited thereto. In the embodiment, sizes of the first transparent net points P1 and the second transparent net points P2 range from microns to tens of microns to prevent display quality and visual effects of the transmissive display module 300 from being affected.

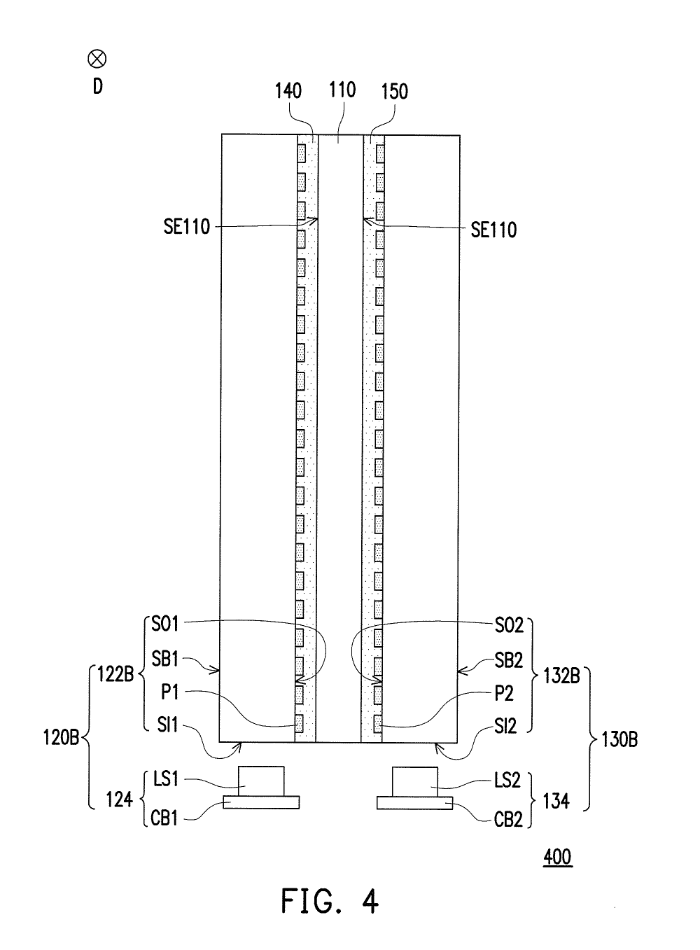

Referring to FIG. 3, the first transparent net points P1 are disposed on the first bottom surface SB1, and the second transparent net points P2 are disposed on the second bottom surface SB2, but the invention is not limited thereto. Referring to FIG. 4, the difference between a transmissive display module 400 illustrated in FIG. 4 and the transmissive display module 300 lies in the first transparent net points P1 being disposed on the first light emitting surface SO1 of a first light guide plate 122B of a first light source module 120B of the transmissive display module 400. Moreover, the second transparent net points P2 are disposed on the second light emitting surface SO2 of a second light guide plate 132B of the second light source module 130B.

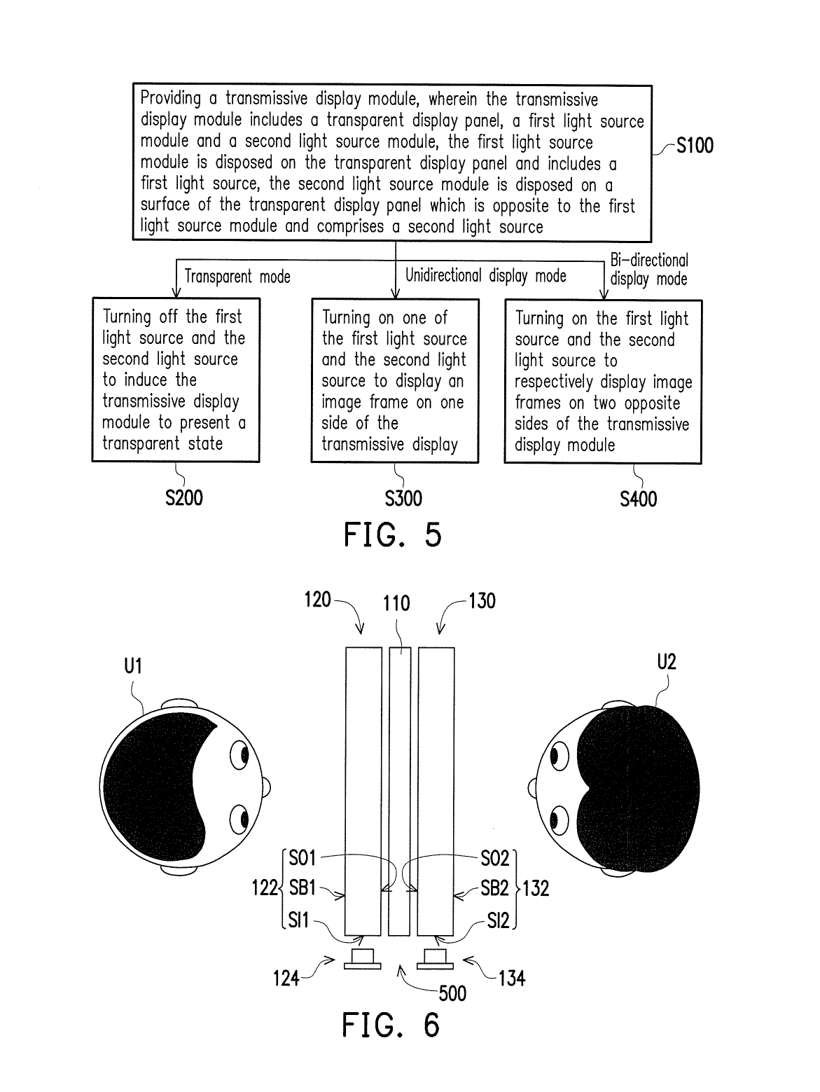

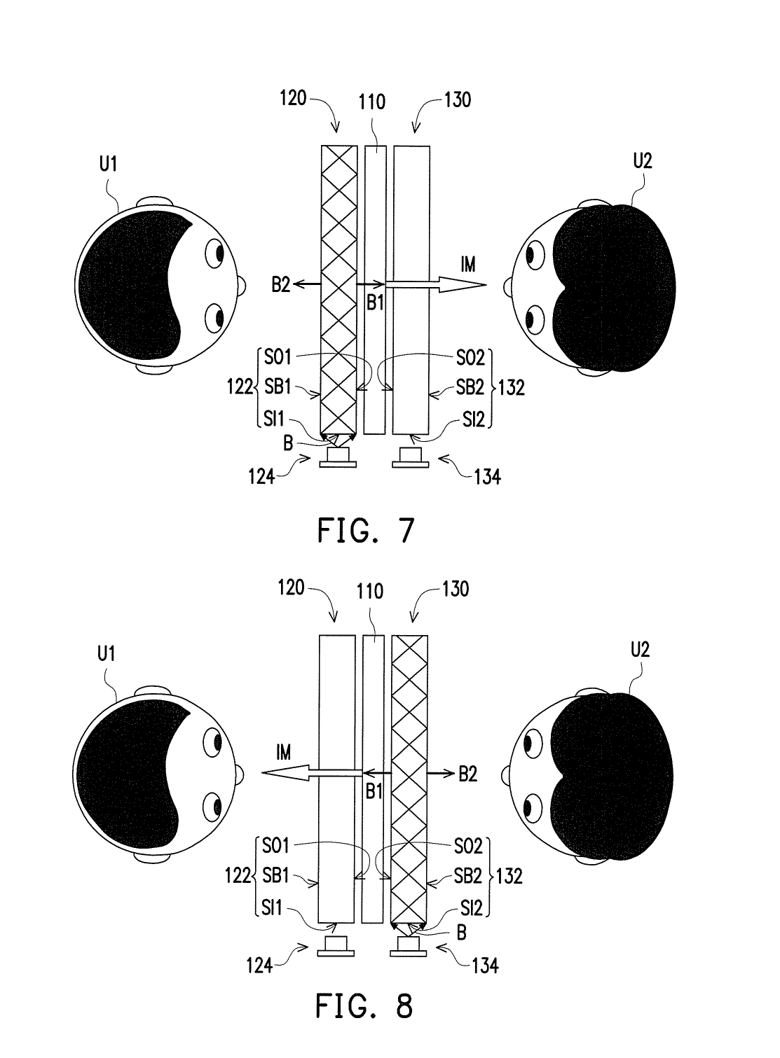

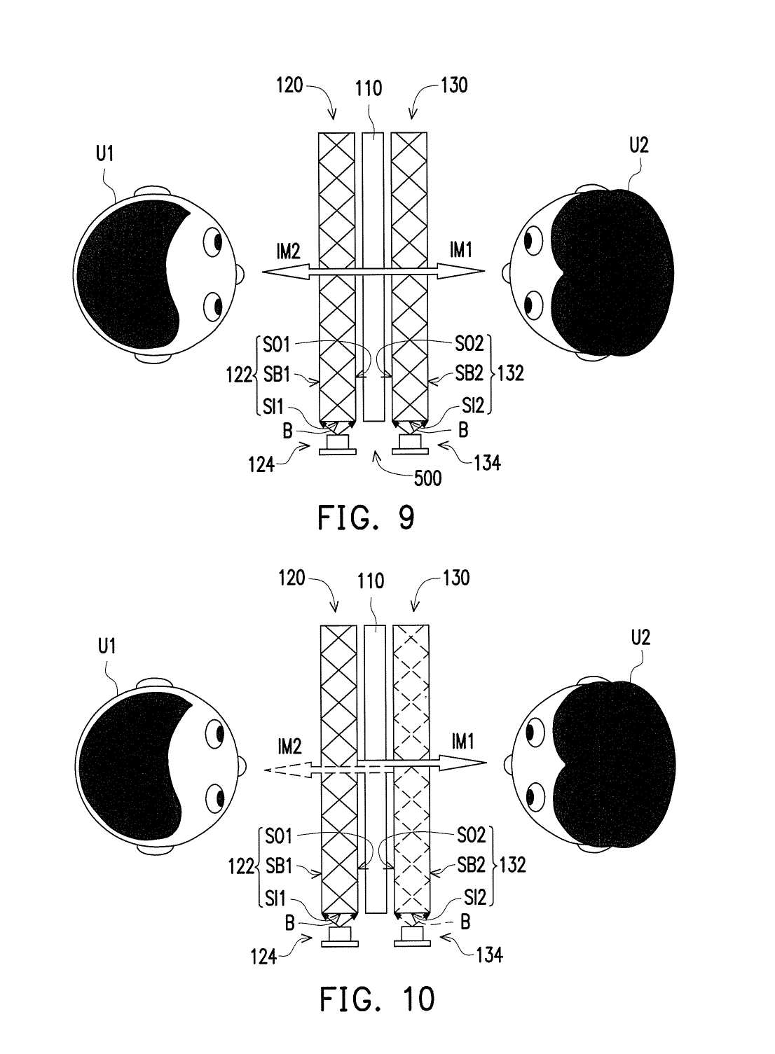

A driving method of a transmissive display module will be described with reference to FIG. 5 together with FIG. 6 to FIG. 10. FIG. 5 is a flowchart illustrating a driving method of a transmissive display module according to an embodiment of the invention. FIG. 6 is a schematic diagram illustrating the transmissive display module in a transparent mode. FIG. 7 and FIG. 8 are schematic diagrams respectively illustrating the transmissive display module in a unidirectional display mode. FIG. 9 and FIG. 10 are schematic diagrams respectively illustrating the transmissive display module in a bi-directional display mode.

Referring to FIG. 5 to FIG. 10, the driving method of the transmissive display module includes the following steps. First, a transmissive display module 500 is provided. The transmissive display module 500 includes a transparent display panel 110, a first light source module 120 and a second light source module 130. The first light source module 120 is disposed on the transparent display panel 110 and includes a first light source 124, and the second light source module 130 is disposed on a surface of the transparent display panel 110 which is opposite to the first light source module 120 and includes a second light source 134 (step S100). In the embodiment, the first light source module 120 and the second light source module 130 are side-type light source modules. The first light source module 120 further includes a first light guide plate 122, and the second light source module 130 further includes a second light guide plate 132. Details related to the first light guide plate 122 and the second light guide plate 132 may refer to the descriptions set forth above and will not be repeated hereinafter. Additionally, the adhesive layer 140 or 150 adhering the light guide plates and the transparent display panel 110 may be selectively employed for the transmissive display module 500 to improve mechanical strength, and the descriptions related thereto may also refer to the descriptions set forth above and will not be repeated hereinafter. The transmissive display module 500 may employ a controller (not shown) to control the turning on and the turning off of the first light source 124 and the second light source 134 and the timing sequence of the transparent display panel 110, so as to provide various display modes, such as a transparent mode, a unidirectional display mode and a bi-directional display mode. In the transparent mode, the first light source 124 and the second light source 134 are simultaneously turned off, such that the transmissive display module 500 presents a transparent state (step S200). In the unidirectional display mode, one of the first light source 124 and the second light source 134 is turned on, such that an image frame IM is displayed on one side of the transmissive display module 500 (step S300). In the bi-directional display mode, the first light source 124 and the second light source 134 are turned on, such that image frames (e.g., a first image frame IM1 and a second image frame IM2, referring to step S400) are displayed on two opposite sides of the transmissive display module 500.

Referring to FIG. 6, the transparent display panel 110 in an on state is transparent, for example, and thus, the transparent display panel 110 in the transparent mode is, for example, in the on state, such that the entire transmissive display module 500 is transparent, and therefore, users U1 and U2 are able to see each other in the transparent mode.

Referring to FIG. 7 and FIG. 8, the transparent display panel 110 in the unidirectional display mode is also in the on state, such that the image frame IM is output from the transmissive display module 500 through the other one of the first light source module 120 and the second light source module 130. Referring to FIG. 7, when the first light source 124 is turned on, and the second light source 134 is turned off, a light beam B from the first light source 124 which enters the first light guide plate 122 through the first light incident surface SI1 is transmitted back and forth between the first light emitting surface SO1 and the first bottom surface SB1 due to total internal reflection. Therein, part of the light beam B (e.g., a light beam B1) emitting from the first light emitting surface SO1 and sequentially passing through the transparent display panel 110 and the second light source module 130 is transmitted to the user U2 whose location is next to the second light source module 130 while part of the light beam B (e.g., a light beam B2) emitting from the first bottom surface SB1 is transmitted to the user U1 whose location is next to the first light source module 120. The light beam B1 passing through the transparent display panel 110 is converted from an illuminating light beam into a displaying light beam with image information, and thus, the user U2 is able to view the image frame IM. On the other hand, the light beam B2 transmitted to the user U1 does not pass through the transparent display panel 110, and thus, the user U1 views that the first light guide plate 122 is illuminated.

Referring to FIG. 8, when the second light source 134 is turned on, and the first light source 124 is turned off, the light beam B from the second light source 134 which enters the second light guide plate 132 through the second light incident surface SI2 is transmitted back and forth between the second light emitting surface SO2 and the second bottom surface SB2 due to total internal reflection. Therein, part of the light beam B (e.g., the light beam B1) emitting from the second light emitting surface SO2 and sequentially passing through the transparent display panel 110 and the first light source module 120 is transmitted to the user U1 whose location is next to the first light source module 120, and part of the light beam B (e.g., the light beam B2) emitting from the second bottom surface SB2 is transmitted to the user U2 whose located in next to the second light source module 130. The light beam B1 passing through the transparent display panel 110 is converted from an illuminating light beam into a displaying light beam with image information, and thus, the user U1 is able to view the image frame IM. On the other hand, the light beam B2 transmitted to the user U2 does not pass through the transparent display panel 110, and thus, the user U2 views that the second light guide plate 132 is illuminated.

Referring to FIG. 9, in the bi-directional display mode, the first light source 124 and the second light source 134 are simultaneously turned on, such that image frames that are heterochiral are displayed on the opposite sides of the transmissive display module 500. Specifically, in the state that both the first light source 124 and the second light source 134 are lit, the light beam emitting from the first light emitting surface SO1 of the first light guide plate 122 is converted into a displaying light beam by the transparent display panel 110 and transmitted to the user U2, such that the user U2 views the first image frame IM1. On the other hand, the light beam emitting from the second light emitting surface SO2 of the second light guide plate 132 is converted into a displaying light beam by the transparent display panel 110 and transmitted to the user U1, such that the user U1 views the second image frame IM2. The first image frame IM1 and the second image frame IM2 are converted into the displaying light beams through the transparent display panel 110 in the same timing sequence, therefore, the first image frame IM1 and the second image frame IM2 have the same image information, but are heterochiral (i.e. the first image frame IM1 and the second image frame IM2 are mirror image frames of each other) due to opposite observation locations.

Referring to FIG. 10, in the bi-directional display mode, the first light source 124 and the second light source 134 may be time-divisionally turned on, and a switching frequency of the first light source 124 and the second light source 134 is half a frame rate of the transparent display panel 110. Specifically, if the frame rate of the transparent display panel 110 is 120 Hz, the switching frequency of the first light source 124 and the second light source 134 is 60 Hz. If a turning-on time of the first light source 124 is 1/120 seconds, 3/120 seconds, 5/120 seconds and so on, a turning-on time of the second light source 134 is 2/120 seconds, 4/120 seconds, 6/120 seconds and so on. Additionally, the transparent display panel 110 displays the first image frame IM1 when the first light source 124 is turned on and displays the second image frame IM2 when the second light source 134 is turned on, in which the first image frame IM1 and the second image frame IM2 are independent from each other. In this way, the users U1 and U2 view independent and different image frames.

In light of the foregoing, the embodiments of the invention achieve at least one of the advantages and effects set forth below. In the transmissive display module of the invention, the adhesive layer adheres the transparent display panel and the first light guide plate, such that the mechanical strength can be improved. In addition, since the refractive index of the adhesive layer is less than the refractive index of the first light guide plate, the light beam from the first light source which enters the first light guide plate can be transmitted in the first light guide plate by means of the total internal reflection, so as to achieve an effect of uniform distribution. Therefore, the transmissive display module of the invention can have ideal mechanical strength and light emitting uniformity. In an embodiment, the first light guide plate can be operated with the narrow distribution angle light emitting elements, such that most of the light beams from the light emitting elements can enter the first light guide plate. Moreover, the driving method of the transmissive display module of the invention can provide various display modes by controlling the turning on and the turning off of the first light source and the second light source and the timing sequence of the transparent display panel.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A transmissive display module, comprising:
a transparent display panel;
a first light source module, disposed on the transparent display panel and comprising:
a first light guide plate, having a first light incident surface; and
a first light source, disposed beside the first light incident surface;
a second light source module, disposed on a surface of the transparent display panel opposite to the first light source module and comprising:
a second light guide plate, having a second light incident surface; and
a second light source, disposed beside the second light incident surface; and
at least one adhesive layer, at least adhering the transparent display panel and the first light guide plate, wherein a refractive index of the adhesive layer is less than a refractive index of the first light guide plate.

2. The transmissive display module of claim 1, wherein the adhesive layer adheres the transparent display panel and the second light guide plate, and the refractive index of the adhesive layer is less than a refractive index of the second light guide plate.

3. The transmissive display module of claim 1, wherein the first light guide plate further has a first light emitting surface, a first bottom surface and a plurality of first transparent net points, the adhesive layer adheres the transparent display panel and the first light emitting surface, the first bottom surface is opposite to the first light emitting surface, the first light incident surface connects the first light emitting surface and the first bottom surface, the first transparent net points are disposed on one of the first light emitting surface and the first bottom surface, the second light guide plate further has a second light emitting surface, a second bottom surface and a plurality of second transparent net points, the second bottom surface is opposite to the second light emitting surface, the second light incident surface connects the second light emitting surface and the second bottom surface, and the second transparent net points are disposed on one of the second light emitting surface and the second bottom surface.

4. The transmissive display module of claim 1, wherein the first light source comprises at least one first light emitting element, a light distribution angle corresponding to 50% of a light intensity of each of the at least one first light emitting element falls in a range less than or equal to 55 degrees, and a sum of light energy of each of the at least one first light emitting element at a light distribution angle greater than or equal to 70 degrees is less than or equal to 10% of a lumen value of the at least one first light emitting element.

5. The transmissive display module of claim 1, wherein the refractive index of the adhesive layer is less than 95% of the refractive index of the first light guide plate.

6. A driving method of a transmissive display module, comprising:
providing a transmissive display module, wherein the transmissive display module comprises a transparent display panel, a first light source module and a second light source module, the first light source module is disposed on the transparent display panel and comprises a first light source, the second light source module is disposed on a surface of the transparent display panel opposite to the first light source module and comprises a second light source;
in a transparent mode, turning off the first light source and the second light source to induce the transmissive display module to present a transparent state;
in a unidirectional display mode, turning on one of the first light source and the second light source to display an image frame on one side of the transmissive display module; and
in a bi-directional display mode, turning on the first light source and the second light source to respectively display image frames on two opposite sides of the transmissive display module.

7. The driving method of the transmissive display module of claim 6, wherein in the transparent mode, the driving method of the transmissive display module further comprises:
turning on the transparent display panel.

8. The driving method of the transmissive display module of claim 6, wherein in the unidirectional display mode, the driving method of the transmissive display module further comprises:
turning on the transparent display panel to output the image frame from the transmissive display module through the other one of the first light source module and the second light source module.

9. The driving method of the transmissive display module of claim 6, wherein in the bi-directional display mode, the method of turning on the first light source and the second light source comprises:
simultaneously turning on the first light source and the second light source to display the image frames that are heterochiral on the two opposites of the transmissive display module.

10. The driving method of the transmissive display module of claim 6, wherein in the bi-directional display mode, the method of turning on the first light source and the second light source comprises:
time-divisionally turning on the first light source and the second light source, wherein a switching frequency of the first light source and the second light source is half a frame rate of the transparent display panel.

11. The driving method of the transmissive display module of claim 10, wherein a first image frame is displayed on the transparent display panel when the first light source is turned on, and a second image frame is displayed on the transparent display panel when the second light source is turned on, and the first image frame and the second image frame are independent from each other.
